(19) United States
(12) Patent Application Publication
(10) Pub. No.: US 2023/0328033 A1
(43) Pub. Date: Oct. 12, 2023

(54) Positive Enforcement Domain Name Service Firewall

(71) Applicant: Gluware IP, LLC., Sacramento, CA (US)

(72) Inventors: Tim Silverline, San Ramon, CA (US); Stanislav Miskovic, San Jose, CA (US); Olivier Huynh Van, Sacramento, CA (US)

(21) Appl. No.: 17/717,616

(22) Filed: Apr. 11, 2022

(51) Int. Cl. H04L 9/40; H04L 61/4511; H04L 43/50

(52) U.S. Cl. CPC H04L 63/0236; H04L 43/50; H04L 61/4511; H04L 63/20

(57) ABSTRACT

A method, a system, and a computer program product for positive domain enforcement. At least one processor receives one or more requests from one or more sources to access data. A source address associated with received one or more requests is determined. The source address associated with received one or more requests is compared to one or more stored request profiles. Based on the comparing, a forwarding mode for received one or more requests is determined. Received one or more requests are transmitted to one or more destinations in accordance with the determined forwarding mode.

### TECHNICAL FIELD

This disclosure relates generally to data processing and, in particular, to positive enforcement domain name service (DNS) firewall.

### BACKGROUND

DNS is one of the fundamental protocols upon which the Internet was built. The technology is used within computer networks to resolve a text based fully qualified domain name (FQDN), such as www.google.com, to a specific resource record (RR), which in most cases resolves to an Internet Protocol (IP) address, such as, for example, 123.123.221.105. Many applications, such as web browsers or mobile phone apps, may use DNS to resolve names when making various queries or establishing connections across a network. DNS makes it easier for users to remember the destinations they want to go by allowing them to remember simple names versus strings of numbers. It also creates an easy way for an adversary to tunnel out of secure corporate networks to exfiltrate data or be used as a covert channel for a user outside of a network to secretly control a system within it. Given that DNS is pervasively allowed to communicate with resources outside of a company's infrastructure, it is a highly desired target for malicious actors as it can be misused to exfiltrate data or serve as a covert communication or command and control channel.

### SUMMARY

In some implementations, the current subject matter relates to a computer-implemented method for positive domain enforcement. The method may include receiving, using at least one processor, one or more requests from one or more sources to access data, determining a source address associated with received one or more requests, comparing the source address associated with received one or more requests to one or more stored request profiles, determining, based on the comparing, a forwarding mode for received one or more requests, and transmitting received one or more requests to one or more destinations in accordance with the determined forwarding mode.

In some implementations, the current subject matter can include one or more of the following optional features. One or more requests may include one or more domain name service (DNS) requests.

In some implementations, one or more requests may include at least one: one or more requests to access data stored on an application server, one or more responses responsive to one or more requests, and any combination thereof.

In some implementations, the method may include generating one or more request profiles based on a plurality of requests to access data, each request profile in one or more request profiles may be associated with a corresponding request to access data in the plurality of requests to access data, and storing the generated request profiles as the stored request profiles. Each request profile may include an identification of the request to access data and a type of the identified request. The identification of the requests may include at least one of the following: a domain name, a subdomain name, a fully-qualified domain name, and any combination thereof.

In some implementations, the forwarding mode may include at least one of the following: a learning mode, a testing mode, an enforcement mode, and any combination thereof.

In some implementations, in the learning mode, at least one processor may be configured to generate and store one or more request profiles based on the received requests, and block transmission of the requests to one or more destinations storing data identified in the received requests. In the testing mode, at least one processor is configured to determine whether the source address associated with the received requests corresponds to one or more stored request profiles and/or whether those profiles include the RR being requested. Upon determining that the RRs received in one or more requests does not correspond to one or more stored request profiles for the source IP address the requests were received from, transmission of the requests to one or more destinations storing data identified in the received requests may be blocked and an alert may be generated. Upon determining that the RRs associated with the received requests corresponds to one or more stored request profiles the source IP address the requests were received from, a simulated transmission of the requests to one or more destinations storing data identified in the received requests may be executed.

In some implementations, in the enforcement mode, at least one processor is configured to determine whether the source address associated with the received requests corresponds to one or more stored request profiles. Upon determining that the RRs associated with the received requests does not correspond to one or more stored request profiles the source IP address the requests were received from, transmission of the requests to one or more destinations storing data identified in the received requests may be blocked. Upon determining that the RRs associated with the received requests corresponds to one or more stored request profiles for the source IP address the requests were received from, the requests may be transmitted to one or more destinations storing data identified in the received requests.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary tunneling system;

FIG. 2 illustrates a domain name service firewall (DNSFW) architecture process;

FIG. 3 illustrates a response policy zones decision process;

FIG. 4 illustrates an exemplary decision process for analyzing client domain name service (DNS) requests;

FIG. 5 illustrates an exemplary process for configuring one or more requirements in connection with a determination which requests may be allowed/denied, according to some implementations of the current subject matter;

FIG. 6 illustrates an exemplary smart DNS proxy system for executing positive DNS enforcement, according to some implementations of the current subject matter;

FIG. 7 illustrates an exemplary process for executing one or more DNS proxy decisions, according to some implementations of the current subject matter;

FIG. 8 is an annotated table containing examples of fields that may be included for each value pair in the DNS profile, according to some implementations of the current subject matter;

FIG. 9 is an exemplary system, according to some implementations of the current subject matter; and

FIG. 10 is an exemplary method, according to some implementations of the current subject matter.

### DETAILED DESCRIPTION

To address these and potentially other deficiencies of currently available solutions, one or more implementations of the current subject matter relate to methods, systems, articles of manufacture, and the like that can, among other possible advantages, provide a positive enforcement domain name service (DNS) firewall, and in particular, a solution to prevent DNS tunneling and command and control (C2) by providing a positive enforcement DNS firewall system.

In some implementations, the current subject matter may be configured to generate a complete profile of DNS requests originating from each source internet protocol (IP) address within an enterprise and subsequently blocking all requests that fall outside of the built profile. The current subject matter may be further to obtain and/or gather DNS request and/or response data via a system of smart DNS proxies, transmit that data to a centralized management system for analytics leveraging machine learning to generate individualized DNS policies for each application server within a network, and enforce those policies using the smart proxies.

In some implementations, the current subject matter may be configured to prevent an initial beacon from an infected application server from ever reaching a destination server, instead of forwarding upstream and only blocking the response and/or subsequent requests once malicious DNS behavior is detected.

Further, in some implementations, the current subject matter may be configured to provide a format for expected DNS communications behavior of an application (e.g., as may be developed by an application developer) that may be similar to the way in which most applications define their Layer 4 communication behavior in system requirements documents.

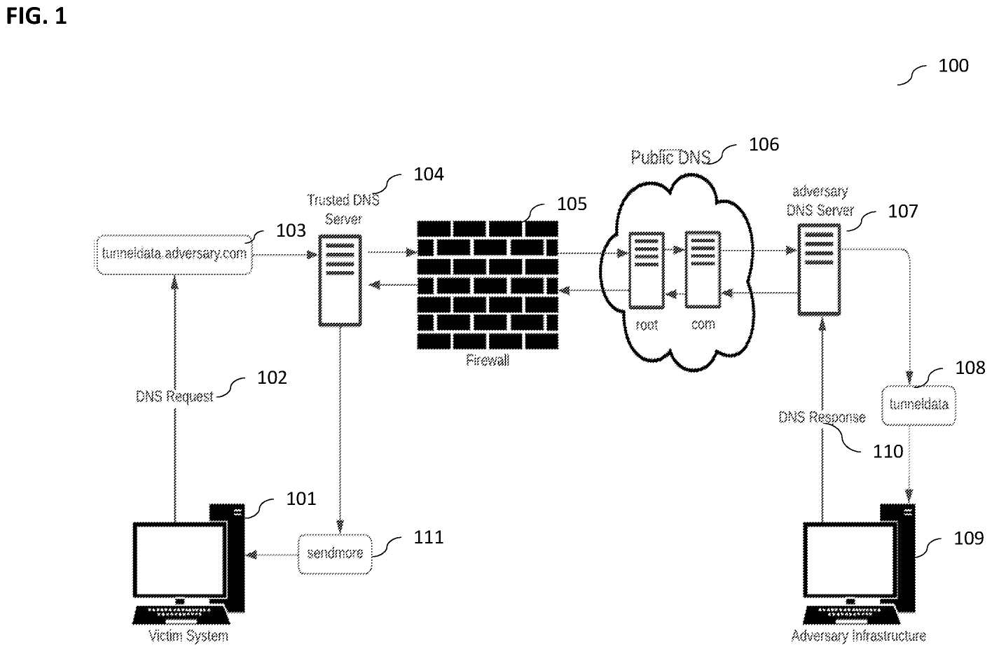

DNS tunneling is used mostly by bad actors, but sometimes by legitimate applications, as a way to move data across the DNS protocol, in a way that typically evades most traditional perimeter network defenses. FIG. 1 illustrates an exemplary tunneling system 100. The system 100 includes a victim system 101, a trusted DNS server 104, a firewall 105, a public DNS 106, an adversary DNS server 107, and an adversary infrastructure system 109. The victim system 101 can transmit a DNS request 102 containing an RR of an FQDN 103 (tunneldata.adversary.com) via the internal trusted DNS server 104. The server 104 then communicates via the firewall 105 and public DNS 106 with the adversary DNS server 107. The adversary's DNS server 107 sends the data tunneled in the DNS request 108 back to the command and control infrastructure of the adversary at 109. A response 110 is generated back from infrastructure 109 towards the victim's system 101 back through public DNS 106 and the firewall 105 with the data being an instruction 111 to send more data back. This allows for a continuous stream of commands and data to traverse through and out of an enterprise network disguised as regular DNS traffic, presenting a significant challenge to network security.

For many years, this challenge was not seen as a huge concern, since secure internal systems should not be trying to communicate with unknown external entities. This vector of malicious communication has also long been underestimated, since DNS was never designed to be a data transmission protocol. However, as the Solarwinds software supply chain breach of 2020 demonstrated, there are multiple vectors by which secure systems can become infected with malware, so any way for those systems to communicate back to malicious actors should be accounted for. The same attack also demonstrated the ease in which attackers were able to use DNS as a data path to coordinate and carry out attacks on dozens of high profile victims, increasing the importance of finding a solution to prevent this tactic.

Software supply chain attacks are a “long con” type of attack where, instead of directly attacking one or more specific targets to achieve their goals, attackers pinpoint specific types of software packages that are widely used or something specifically known to be used by specific targets of the attackers. These attackers then work to breach the systems of the software developers of these specific pieces of software, and then implant malicious code into the software that can allow them to do things like remotely control the systems the code is installed on or exfiltrate any data that can be found by the system where it was installed. In the Solarwinds attack mentioned, malicious actors compromised Solarwinds internal network, systems, and software delivery pipeline. This allowed them to plant malicious software in thousands of enterprises around the world when the Solarwinds customers updated their software and then leverage DNS to further exploit dozens of victims, exfiltrate an enormous amount of data, and chain these attacks together to wreak havoc around the globe.

Existing solutions to the issue of DNS tunneling are not effective as they typically allow all communications unless the communication can be proven malicious. However, by the time something is identified as malicious it may be too late. The current subject matter addresses these problems by performing positive enforcement where no communications are allowed in unless their destinations are pre-profiled as acceptable and/or non-malicious.

Moreover, in some implementations, the current subject matter's approach to analysis of DNS is different from existing DNS firewall solutions, in that a behavioral based approach is used and any enforcement policies are tied to source application servers, thereby not requiring execution of advanced analytics. The positive enforcement approach discussed herein can be advantageous in that it provides network administrators with a complete confidence that DNS is not being used to beacon, exfiltrate data, or be leveraged for C2.

Command and control (C2) is a term used to describe a mechanism by which an attacker can secretly communicate with an internal asset inside of a target organization and remotely request the system to execute commands or perform operations. Often when attackers have compromised a system within a target organization, establishing C2 is the next objective in the initial stage of the attack. Once C2 has been established, adversaries will begin leveraging it to perform reconnaissance inside of the environment to determine targets of value, how to compromise additional systems, which is known as lateral movement, and create additional methods for reconnecting to the network, which is known as establishing persistence. They will usually then try to increase their permissions within the network, known as privilege escalation. The final stage of the attack typically involves exfiltrating sensitive data for nefarious purposes or encrypting data with ransomware and demanding a ransom payment. This exact manner of attack has taken place in countless security incidents including the Home Depot, Marriott, and OPM data breaches.

Once C2 has been established it becomes very difficult to contain a security incident, so an attack should ideally be identified and halted prior. Many products exist to detect software compromise at the system level, but these products have been shown repeatedly to be susceptible to evasion in advanced attacks. While such endpoint security products should absolutely be part of every organization's security strategy, additional detection and mitigation measures within the network stack may need to be implemented to defend against advanced attacks.

The Open Systems Interconnection (OSI) model characterizes computing and networking functions into a universal set of rules and requirements in order to support interoperability between different products and software. In the OSI reference model, the communications between a computing system are split into seven different abstraction layers: Physical, Data Link, Network, Transport, Session, Presentation, and Application. In the OSI model, Layer 4 (the Transport layer) manages the delivery and error checking of data packets. It regulates the size, sequencing, and ultimately the transfer of data between systems and hosts. Data packets are the individual elements that application information is broken down into and eventually sent across the lower levels of the OSI model as they eventually transmit the physical layer to move between different systems. The transport layer also contains information on the network ports on which the data packets flow.

The two most common protocols used in the transport layer are the Transmission Control Protocol (TCP) and Universal Data Protocol (UDP). Both TCP and UDP have 65,535 possible ports to use for both the source and destination fields in network packets. TCP is a connection-oriented protocol, which means a connection is established and maintained until the applications at each end have finished exchanging messages. UDP is classified as a datagram protocol, or connectionless protocol, because it has no way of detecting whether both applications have finished their back-and-forth communication. Instead of correcting invalid data packets, as TCP does, UDP discards those packets and defers to the application layer for more detailed error detection. DNS operates most commonly on UDP using port 53, but also uses TCP port 53 in certain cases.

A firewall (typically, considered as a first network security technology) is a system that connects multiple network segments together, and has the capability to allow or deny certain network traffic between these segments based upon different criteria. Segments are used in most organizations to separate systems which have different value levels and therefore should be treated and protected differently. The purpose of the firewall is to protect systems by preventing communication with malicious or undesirable destinations or with systems or ports which they have no need to communicate with. When firewalls were first introduced, the most common method of configuration, especially for perimeter firewalls which connect to the Internet, was in a negative enforcement model. Negative enforcement policies consist of explicitly denying certain outbound traffic to prevent communication, while implicitly allowing all other outbound traffic to pass through. This made it straightforward to deploy firewalls without breaking existing functionality that users of the network expected to work while still allowing administrators to block the traffic of most concern.

Over the years, as cyber adversaries skills have continued to improve, and as attacks have become both more frequent and more complex, network security administrators have realized that one of the biggest tools they have to prevent breaches is to become more granular in their outbound traffic policies. For internal application servers, typically this has meant limiting them from any connectivity outbound except for that which is needed for the application servers to operate. This is what is known as positive enforcement, i.e., allowing only the network traffic which has been identified as necessary, and implicitly denying the rest. The difference in this approach is that, even if an application server were compromised at the software level, without a mechanism for it to communicate back to the malicious actors which infected the system, no data can be pulled from the environment and no further damage can be caused. In other words, no C2 can be established through a firewall with a properly configured positive enforcement policy, except when it comes to DNS.

Unfortunately, there is no simple mechanism to translate this highly effective outbound firewall policy strategy to DNS today, leaving a gaping hole in every network. There are multiple products on the market which were designed to mitigate the threats that unfiltered DNS traffic introduces, but they all operate in the negative enforcement model that legacy firewalls were traditionally deployed using. The model which has long seen to be ineffective against advanced attacks. One of the reasons for that is that since DNS is a relay technology, often the DNS security technologies inside of organizations, i.e., DNS firewalls (DNSFW), are blind to the original source of the DNS requests.

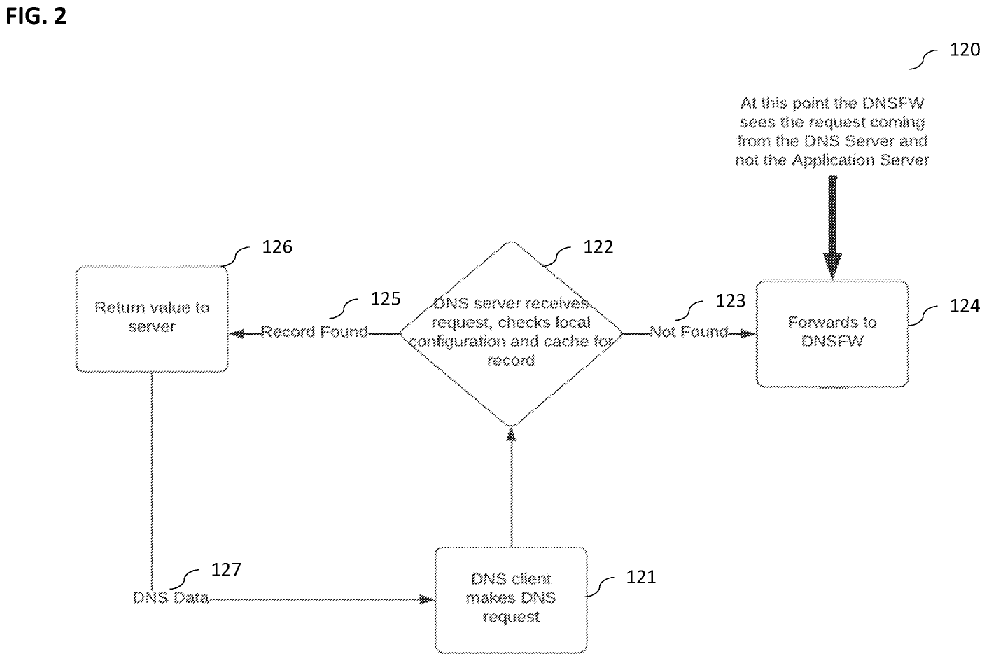

FIG. 2 illustrates a DNSFW architecture process 120. The process 120 starts when the original DNS client 121 makes a request to the DNS server 122. Upon receiving the request, the DNS server 122 determines if the RR requested exists either in its local configuration, or within its cache of previously responded requests. If it does not exist, at 123, it then sends a request to the upstream DNS firewall 124, but the request sent to the DNSFW is sent from the IP address of the internal DNS server 122. When the request makes it to the DNSFW, it appears to come from the internal DNS server 122 instead of the actual client 121. Without being able to identify the original source of the DNS request 121, the DNSFW is limited in the granularity of the policies it can enforce.

If the record is found, at 125, a value is returned to the server, at 126. A DNS data 127 is then transmitted back to the DNS client 121 that made the original request.

Traditional firewalls are able to make a decision to allow or deny traffic based on the 5-tuple characteristics of that traffic, i.e., a source IP address, a destination IP address, a source port, a destination port, and a protocol in use. This allows for a great amount of granularity in policies and for policies to be based upon the original source of the traffic. Since traditional DNSFWs do not have this same visibility into traffic, as shown in FIG. 2, they must make their decisions entirely based upon the DNS record being requested and the data seen in the request and response. While existing DNSFW technologies perform advanced analytics on the DNS traffic to identify malicious traffic and block it, they fail to “catch” every single malicious request.

Another reason DNSFWs operate in a negative enforcement model is the operational model of BIND which is one of the most popular DNS software in use today. Most DNSFWs, if not all, leverage BIND in their underlying software architecture to process DNS requests. In 2010, the Internet Services Consortium (ISC) developed a technology for use with BIND entitled response policy zones (RPZ) to help address DNS security. RPZ works by enabling custom handling for collections of domains (zones). RPZ enabled DNS servers have the capability to connect to multiple different sources to obtain updated information with which to leverage in their policies. There are many services available that can feed threat intelligence into RPZ enabled DNS servers which can in turn be used to block known bad RRs. RPZ was designed in a negative enforcement model—a zone specifying the items to block must be defined—and all of the DNSFWs leveraging it as the underlying software architecture for their platforms seem to operate in this model because of that.

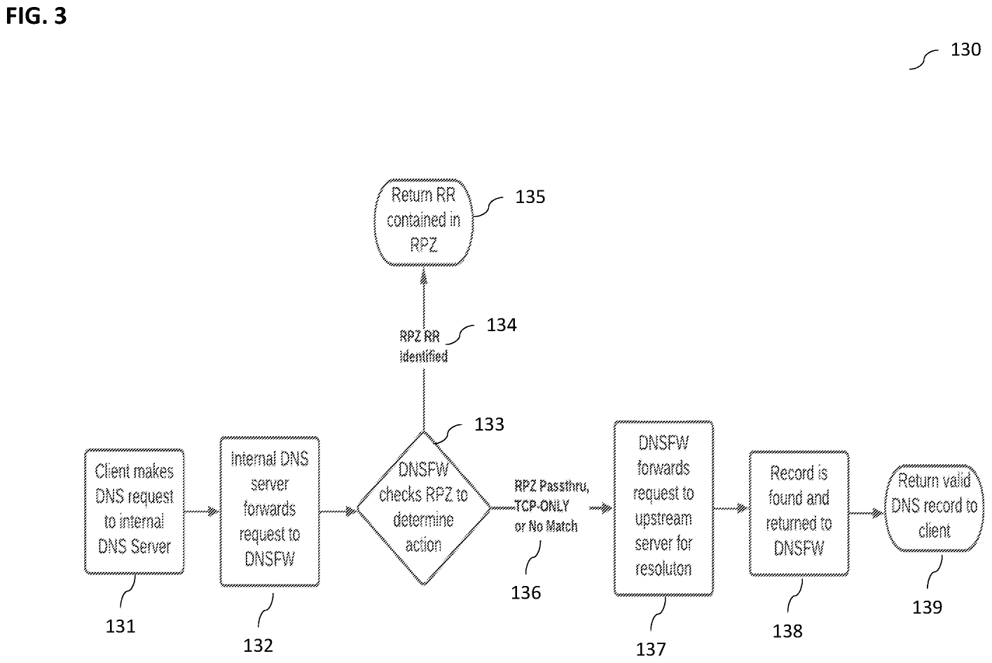

FIG. 3 illustrates the RPZ decision process 130. At 131, a client makes a request to the DNS Server, which, at 132, transmits a request to the DNSFW (assuming no record was identified as shown in FIG. 2). The DNSFW then checks, at 133, its response policy zones and if the RR is found, at 134, acts according to the policy defined, such as by returning RR contained in RPZ, at 135.

There are multiple different types of responses that can be configured within RPZs. These include “PASSTHRU,” “TCP-ONLY,” “DROP,” “NODATA,” and “NXDOMAIN.” PASSTHRU specifically instructs BIND to allow the query to resolve correctly while also generating a log of the request. TCP-ONLY requires the request and response to only use the TCP protocol, instead of UDP. DROP, NODATA, and NXDOMAIN are different ways in which BIND can be instructed to prevent resolution of the RR. DROP simply discards the request, NODATA returns a DNS response of NODATA, and NXDOMAIN, the most commonly configured RPZ response, returns a response of NXDOMAIN.

NXDOMAIN (non-existent domain) is a DNS response message that is returned back to any DNS request as a way to tell the originator of the request that the RR is not resolvable as requested. The NXDOMAIN response sent back in an RPZ reply for domains that are blocked by the RPZ policy is informing the requesting client that the record does not exist. It may in fact exist, however, the requesting client cannot resolve the record with the NXDOMAIN response so the connection to the resource fails. All three of these latter responses (DROP, NODATA, NXDOMAIN) achieve the same result of preventing the resolution of the DNS record and preventing communication with the intended resource.

Referring back to FIG. 3, unless the specific RR is referenced within an RPZ, the request will be forwarded, at 136, out to the destination DNS server, where DNSFW forwards, at 137, the request to upstream server for resolution, whereby the record is found, at 138, and returned to DNSFW, and subsequently, at 139, the valid DNS record is returned to client. This allows for DNS beacons from compromised systems to reach malicious servers even if the DNSFW identifies the traffic as malicious upon receiving the response from the destination. A DNS beacon is a request sent out from a compromised system over DNS to communicate back to an attacker's infrastructure to and is used by malicious attackers as a way to verify that the installation of the compromised software was successful. In software supply chain attacks, this can be used to identify and select specific victims to focus on by the attackers. In the 2020 Solarwinds supply chain attack, malicious actors used DNS beacons to prioritize high value targets such as government entities and cybersecurity software providers including FireEye—the company that originally identified the attack as the hackers made off with their entire red team toolkit, a collection of advanced offensive security software they used to identify vulnerabilities inside of their customers and help protect them. The leak of this software toolkit represented a challenge for the entire cybersecurity industry since many undisclosed exploits were contained in this data theft and this provided threat actors with a slew of new methods for targeting additional enterprises. The hackers in this attack were able to both ignore the targets of lower value and even used the DNS beacons to disable the malicious software in those lower value targets, reducing the likelihood of having their software detected before they were able to carry out the attacks against all of their intended high value targets.

Yet another reason DNSFWs operate in a negative enforcement model is because filtering DNS with the same granularity that properly constructed positive enforcement firewall policies are implemented would be very challenging due to the enormous amount of DNS requests required for networked systems to function. With advancements in technology including machine learning and advanced analytics, profiling the DNS behavior of individual application servers is an achievable feat. The complexity of profiling end user DNS traffic involves a larger number of individual factors and destination endpoints.

There exist various methods by which an organization can completely disable DNS tunneling today. One method is to disable forwarding on their internal DNS servers. DNS forwarding is important to how DNS operates. When a DNS server receives a request, it will check to determine whether the request matches any of the locally configured domains on the server. If it finds a match, it will return the result that is configured in its settings, or if it has cached a reply to the RR due to a previous matching request. If it does not match any locally configured domains, and it is not found in the cache, the DNS server will forward that request to an upstream DNS server to request resolution. This process continues until the request reaches a DNS server that is configured with the requested domain, or until one of the servers responds that the requested record does not exist. This forwarding process is what allows for DNS to be used as a tunneling mechanism and easily evade network firewall detection. When the request is traversing the firewall, it will almost always be sent to a trusted upstream server—the same one that all of the other requests are forwarded to. This makes it impossible for the firewall to treat malicious requests differently because it looks identical to a benign request. However, after the DNS request leaves the network, the upstream server—which most organizations normally have no control over—can then forward that request to anywhere, including malicious DNS servers controlled by adversaries. Disabling forwarding completely would shut down the ability of any system to tunnel out of a network using DNS, but it would also prevent those same systems from resolving any queries headed to external DNS servers on the internet.

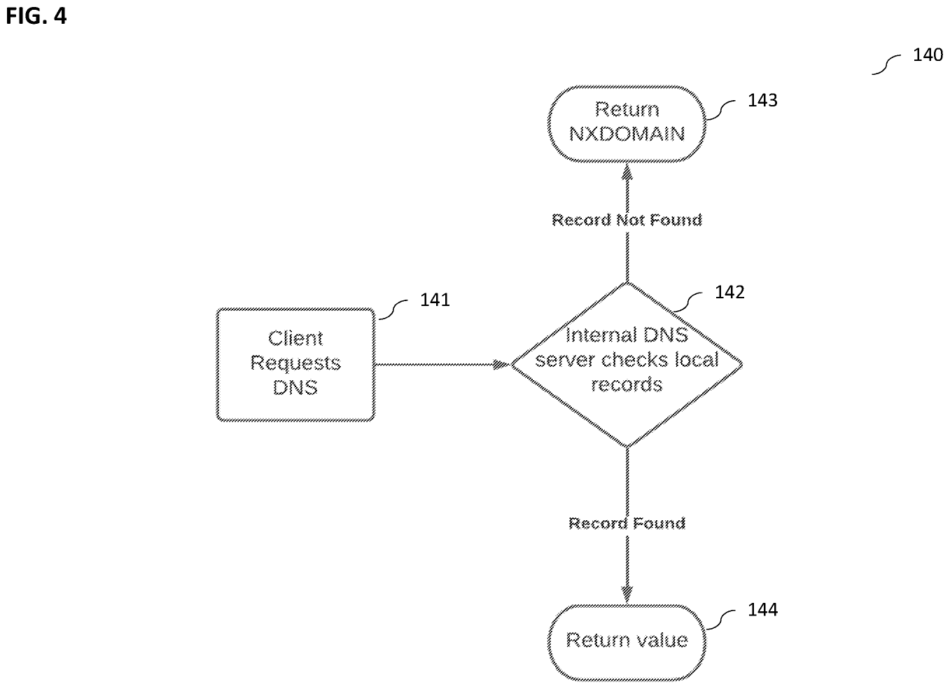

FIG. 4 illustrates an exemplary decision process 140 for analyzing client DNS requests. The process 140 is similar to the RPZ decision process 130 shown in FIG. 3. However, using the process 140, anything that is not configured in the local DNS server returns a failed NXDOMAIN response. As shown in FIG. 4, at 141, a DNS server receives a client request. At 142, the DNS server checks local records, if a record is not found, it will return NXDOMAIN response, at 143. Otherwise, if the record is found, a value is returned, at 144. While certain application servers might not require DNS resolution of external domains, many of them do, making this method a partial solution that is not able to holistically cover any organization's DNS requirements, and therefore not a viable option.

Another existing method to completely disable DNS tunneling involves removing DNS server configuration from the application servers and relying upon local host files for resolution. Host files are local text-based files that reside on most operating systems that provide the ability to correlate specific DNS records to the IP addresses in the same way that DNS servers do. This method, unlike the one mentioned above, can allow for communication with external domains. It has several drawbacks, however, that make its use impractical. Management of host files at scale in any sizable network is quite a challenge. There are not any commercially available solutions that address this, and this would also disable the dynamic nature of DNS. One of the benefits of DNS is the ability to change what records resolve to. This allows for seamless transition when companies are changing how their applications operate. For example, a company may be deploying their technology into a new data center with new public IP addresses. When the setup of the new infrastructure is complete, they simply change the DNS record to point to the new IP addresses, and the users of their application can begin using the new infrastructure without any changes on their end. A hosts file system would negate this capability unless an updating mechanism was introduced into the overall solution, which would be challenging to implement. Another huge drawback of a host-based solution to prevent DNS tunneling is the lack of visibility into the end client behavior. If a system was compromised and began trying to establish C2 over DNS, these requests would not succeed, but neither would the system administrators notice the new behavior which would allow them to investigate and remediate the problem.

In some implementations, the current subject matter may be configured to address the above issues by preventing DNS tunneling, while allowing for a full operation expected of application servers. In particular, the current subject matter may implement a smart DNS proxy that may be configured to determine an expected behavior of its clients through profiling using machine learning. It may further be configured to drop and generate one or more alerts on all requests outside of the profiles it may have generated.

In some implementations, the current subject matter may be configured to learn profiles of legitimate DNS behavior corresponding to DNS activity of applications that run on a particular server and of the operating system on which the server is running (e.g., either in unison and/or individually). As a result, the current subject matter may be configured to generate a list of DNS domains to which the server may be configured to connect legitimately. Once this list is established, the server may only be allowed to send DNS requests related to the identified domains (with some exceptions which enable the proxy's adaptation and additional learning capabilities). In some implementations, the learning process may be pre-provisioned and/or actively obtained.

In some exemplary implementations, pre-provisioned learning may include one or more of the following. For example, an operator of a smart DNS proxy may configure an externally obtained list (and/or a part of the list) of benign (i.e., non-malicious) DNS domains for a particular server, such as, for example, an application developer providing a list of such domains. Alternatively, or in addition to, the pre-provisioned learning may be configured to leverage one or more previously learned profiles during an active learning phase, e.g., a vendor of the smart DNS proxy may issue learned profiles of a DNS behavior for each of the server operating systems, as well as a number of common server applications (e.g., MySQL, postgreSQL, Active Directory, etc.). In yet another exemplary implementation, an organization having smart DNS proxies may learn a DNS profile for a particular server configuration once and apply it on each new server instance having a similar configuration (e.g., either in future and/or at other sites/locations).

The active learning of a server's non-malicious DNS behavior may include: (a) performing observations of the server's DNS requests over a period of time and making initial profiles, (b) confirming that all such requests are indeed non-malicious, and (c) finally updating the existing behavioral DNS profiles with new non-malicious DNS behaviors and/or removing the DNS behaviors which became compromised (e.g., malicious, and/or suspected of malice, etc.) in the meantime. Exemplary observations of the server's DNS behaviors may include letting the server run over a period of time and capturing all DNS requests it makes, and/or doing the same with a group of similarly configured servers in order to capture behavioral modes across the server group, and/or fuzzing/activating various application functionalities during the observation, etc.

The current subject matter may then confirm that observed DNS requests are indeed non-malicious, i.e., that the server or its applications have not been already compromised at the time of the observation. For example, in a recent Solarwinds incident, Solarwinds software itself was shipped by its vendor as readily compromised—without verification, smart DNS proxy would wrongly learn to allow communication with compromised DNS domains in this case. Some of the ways to confirm that observed DNS requests are non-malicious may include: ensuring that none of the requested DNS domains is in publically known lists of malicious DNS domains, and/or verifying using machine learning that the requested domain names are not generated by malicious algorithms (such as, for example, the case of malicious DGA domains), and/or verifying that the requested domains are not short lived or recently registered (which is another property of malicious DNS domains), etc. Verification of requested DNS domains may also be performed using one or more natural language processing (NLP) machine learning methods. For example, DNS requests issued by a group of similarly configured servers may be observed to determine one or more patterns and/or outliers across one or more requested domain names (e.g., names belonging to identified patterns across the servers are likely to be benign, while outliers may need to be additionally evaluated).

To account for any changes to DNS servers, domains, etc. (and/or their previously determined non-malicious nature), such as, use of new DNS servers, domains, etc. by applications, the current subject matter may be configured to execute periodic and/or on-demand re-learning of non-malicious DNS profiles, and identify occasions when re-learning may be useful/beneficial. To execute such periodic and/or on-demand re-learning, the smart DNS proxy may be configured to schedule one or more re-learning intervals (e.g., re-learn DNS behaviors once a month, once a week, etc.) and/or explicitly request for them at any time (e.g., when server users start reporting application failures and/or connectivity issues and/or for any other reasons).

In some implementations, to identify when re-learning may be useful and/or beneficial, the current subject matter may be configured to execute, for example, tracking an increase in a number of distinct domains that are being denied by the smart DNS proxy and determining that such requested/denied domains are not related (e.g., by comparing their domain names using, for example, NLP algorithms, and/or by the domains not resolving to a similar IP address space, etc.). Alternatively, or in addition to, identification of when to execute re-learning may include identifying outliers in the rate and/or number of denied DNS resolutions. In some exemplary implementations, the current subject matter may also be integrated into a “ticketing” system that may be configured to allow for any newly introduced DNS behavior to be further analyzed, such as, by system administrators, application owners responsible for the systems with changing behavior, and/or any other users. The ticketing system may be used when re-learning has been initiated and may be configured to use one or more lists of newly introduced DNS behavior (each corresponding to a “ticket”) for analysis. Once the new DNS behavior has been understood and determined to be non-malicious, the ticketing system may be used for the purposes of formally approving it as part of the DNS profiles. This process may allow for applications with changing DNS behavior to resume full operation as quickly as possible while still ensuring that no new malicious behavior is unintentionally appended to the existing DNS profiles.

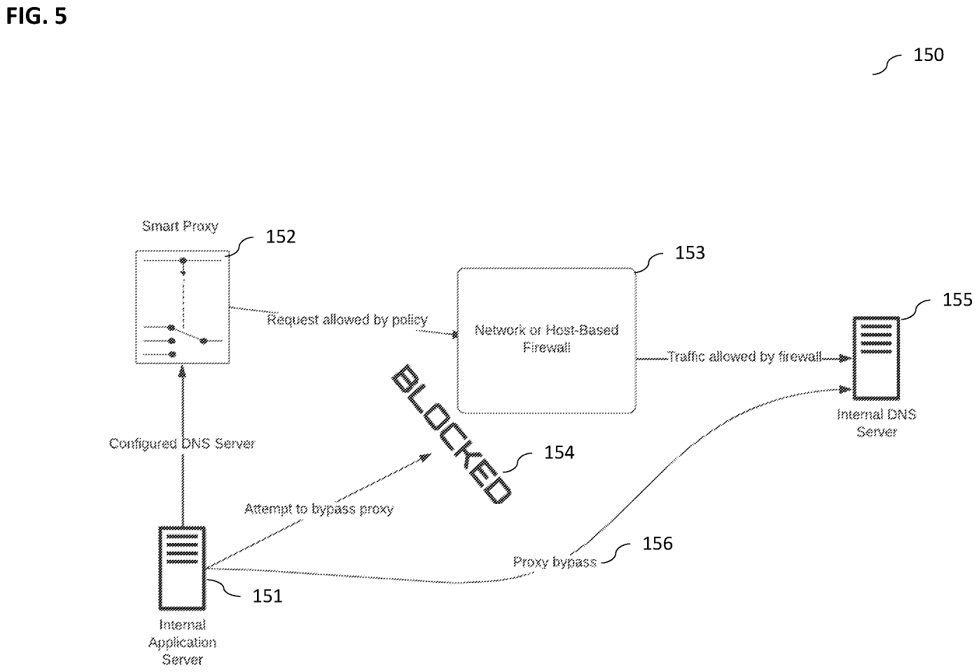

Further, in some exemplary implementations, the current subject matter's smart DNS proxy, prior to forwarding requests between a client and a DNS server, may be configured to determine which requests to allow and/or deny based upon a policy that may be derived from the application server's learned behavior and/or through DNS profiles provided by the application developers. FIG. 5 illustrates an exemplary process 150 for configuring one or more requirements in connection with a determination which requests may be allowed/denied, according to some implementations of the current subject matter. The process 150 may be executed between an internal applications server 151, a smart DNS proxy component 152, a network/host-based firewall 153 and an internal DNS server 155.

The DNS proxy component 152 may be configured to be the first hop in DNS resolution for any application servers 151, i.e., all traffic may be configured to be directed to the component 152. In this case, the DNS proxy component 152 may be configured to be the DNS server for all application servers. Further, the system 150 may be configured to prevent, at 154, any DNS requests from all internal applications servers 151 from reaching alternative DNS servers other than the proxy component 152. This may be accomplished through either the network firewall and/or a host-based firewall 153. To prevent attempts, at 156, to bypass the proxy component 152, internal DNS servers 155 may be configured to only respond to traffic originating from the DNS proxy component 152, and any end-user segments.

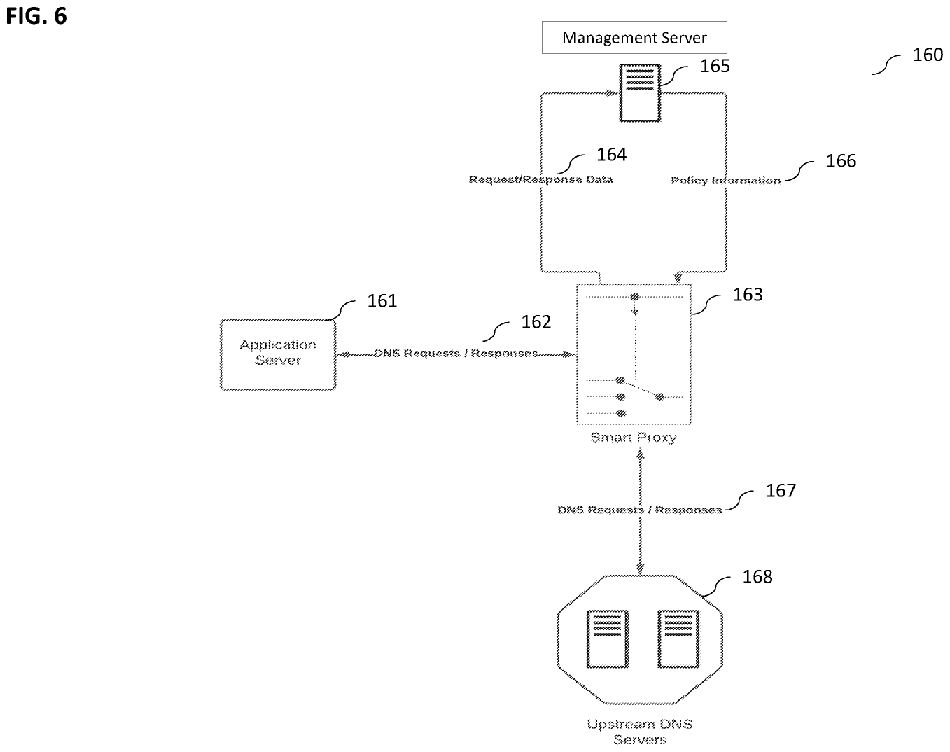

FIG. 6 illustrates an exemplary smart DNS proxy system 160 for executing positive DNS enforcement, according to some implementations of the current subject matter. The system 160 may be configured to include one or more application servers 161, a smart DNS proxy component 163 (similar to smart DNS proxy component 152 shown in FIG. 5), a centralized management server component 165, and one or more upstream DNS servers 168. The servers 168 may be configured to store and/or process DNS request data that may be requested by one or more application servers.

The components of the system 160 may include one or more processors, one or more memories, and/or any combination of hardware/software, and may be configured to execute smart DNS proxy processes for positive enforcement associated with DNS requests. One or more components of the system 160 (e.g., DNS proxy component 163) may include one or more artificial intelligence and/or learning capabilities that may rely on and/or use various data, e.g., data related to and/or identifying one or more DNS requests and/or any associated information, etc.

The elements of the system 160 may be communicatively coupled using one or more communications networks. The communications networks can include at least one of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

The elements of the system 160 may include any combination of hardware and/or software. In some implementations, the elements may be disposed on one or more computing devices, such as, server(s), database(s), personal computer(s), laptop(s), cellular telephone(s), smartphone(s), tablet computer(s), and/or any other computing devices and/or any combination thereof. In some implementations, the elements may be disposed on a single computing device and/or can be part of a single communications network. Alternatively, the elements may be separately located from one another.

The application server component 161 may be configured to transmit/receive any DNS requests/responses to/from the DNS proxy component 163. The DNS proxy component 163 may be configured to transmit/receive DNS requests/responses 167 to/from one or more upstream DNS servers 168. The DNS proxy component 163 may be configured to transmit any DNS log (e.g., request/response) data 164 to the management server component 165 for processing. In response, the management server component 165 may use/transmit policy information 166 to the DNS proxy component 163 that may be used to determine whether or not a particular request/response is/is not malicious/non-malicious. The DNS proxy component 163 may be configured to use this information to determine further processing of the requests/responses, e.g., transmitting (and/or preventing transmission) any received responses to the application server 161 and/or upstream DNS servers 168, transmitting (and/or preventing transmission) any received requests to the upstream DNS servers 168, etc.

As shown in FIG. 6, the DNS proxy component(s) 163 may be configured to connect back to and may be managed centrally by the management server 165. This may provide security and network administrators visibility into DNS behavior of the application servers 161. It may also provide the system 160 with information required to profile and build positive enforcement DNS firewall policies. The management server 165 may be configured to continuously ingest log data 164 from the DNS proxy component 163, and may use this data to map all requests that are being transmitted from each application server 161 independently. Centralized management of global DNS by the management server 165 across the system 160 (e.g., an enterprise environment) may provide many advantages. One of the advantages may include an ability to quickly enforce policy on DNS requests/responses across the entire system 160 as a response to any security events. As security events are identified, policies may be updated in real time to prevent specific DNS communication that might represent a threat to the organization. The system 160 may also be connected into other threat analytics systems within the enterprise to automatically update DNS communication policies based upon certain events.

Further, the management server 165 may be configured to associate IP addresses of the different servers to one or more named functions of application servers 161. If multiple servers 161 are serving the same purpose, such as, for redundancy purposes (e.g., disaster recovery, etc.), all such servers may be assigned the same function. This way DNS behavior of these servers may be analyzed collectively. Further, a uniform policy may be developed and be applied to all of them in a consistent manner. Additionally, this may allow for rolling out additional instances of each application server 161 type quickly without requiring a learning phase.

In some implementations, once the DNS proxy component 163 has been deployed and the application servers 161 have been configured to use them, the system 160 may be configured to execute a learning phase. During this phase, all DNS communications may be transmitted through the DNS proxy component 163 and logged. The management server 165 may continuously gather the data, at 164, being streamed to it from the DNS proxy component 163 and use machine learning (ML) to generate one or more profiles for every data record being requested from each individual client (e.g., application server 161). The management server 165 and/or the DNS proxy 163 may be configured to use machine learning to process all incoming DNS requests, separate them by source IP address(es), and then create a profile for each source IP address that corresponds to application servers 161 as they were associated by an administrator.

In some exemplary implementations, the management server 165 may be configured to generate one or more user interfaces (not shown in FIG. 6) that may be configured to display the determined profile data and provide a visual view of the DNS traffic that is transmitted, e.g., separated by domain, and showing how many different records in each domain were requested by each type of application server 161. A user (e.g., an administrator) may select one or more domains to view all of the individual records being requested and a hit count for how many times each one was requested. The administrator may also have a capability within this view to permanently add/remove either domains and/or individual records to the allow policy for a particular application server. The administrator may also leverage the behavior based learning functionality of the product to build and enforce policy by the DNS requests that the DNS proxy component 163 observes, reducing the administrative overhead required to operate the system 160. Alternatively, or in addition to, the system 160 may be configured perform adding/removing of domains/records based on a specific policy that may have been previously generated as a result of machine learning activities.

In some implementations, a DNS policy profile may be generated by the system 160 for each application server 161 type (and/or groups of a particular type) from which DNS requests may be received. The DNS policy profile may be generated after a predetermined period of time during which learning takes place. By way of a non-limiting example, such period of time may be 24 hours, 72 hours, 1 week, and/or any other period of time. The period of time may be predetermined for a particular system 160 and/or type of traffic that is generated and/or expected to be generated.

In some implementations, a DNS policy profile may be suggested using statistical analysis to determine when the proposed policy has reached a point where no new records are being detected after a certain amount of elapsed time. Alternatively, or in addition to, one or more prior historical analyses and/or policies may be used either for learning, testing, and/or enforcement.

A DNS profile may be “locked down” (e.g., determined to be complete and/or ready to use) after a predetermined period of time (e.g., 24 hours, etc.) and no new RRs have been requested. In some cases, this may be dependent on a type of applications that are being deployed in a particular system 160. While many applications may be consistent in their DNS traffic behavior during certain periods of time (e.g., one week), other applications may include specific functions that may only occur during a different period time (e.g., once a month) that might not intersect with the initial period of time. For example, these functions may include, but are not limited, to update checking, certain backup functions, etc. This means that a learning phase for such functions (and/or servers 161 executing them) may be longer. Such applications and/or servers 161 may be specifically identified to ensure that a learning phase for determining their DNS profiles is extended. In the event that the system 160 enters an enforcement phase (i.e., a phase during which learned policies are enforced by the system 160 on all DNS traffic) prior to learning of any additional behavior, the system 160 may be configured to learn this new behavior and subsequently add it to the DNS policy for enforcement.

The DNS enforcement policy of the system 160 may be configured to account for how many individual RRs are being requested from each domain and/or subdomain associated with one or more servers 161 during the learning phase and generate a policy accordingly. The policy may allow domains and/or subdomains with one or more individual RR variations during the learning phase. Alternatively, or in addition to, during the learning phase, all RRs from those specific domains and/or subdomains may be allowed to generate a more simple policy. However, the policy may be as granular as desired (e.g., if limited variability is observed), thereby creating a most secure type of positive enforcement policy. Once the administrator user is comfortable with the proposed policy for a particular application server 161 and has accepted it, the policy may be may be tested, e.g., using one or more simulations, and/or put directly into enforcement. In some implementations, the management server 165 may be configured to automatically determine whether a particular policy should be tested and/or placed into enforcement. The management server 165 may use one or more parameters (e.g., time, specific DNS requests, types requests, types of servers, types of applications, etc.) to make such determination.

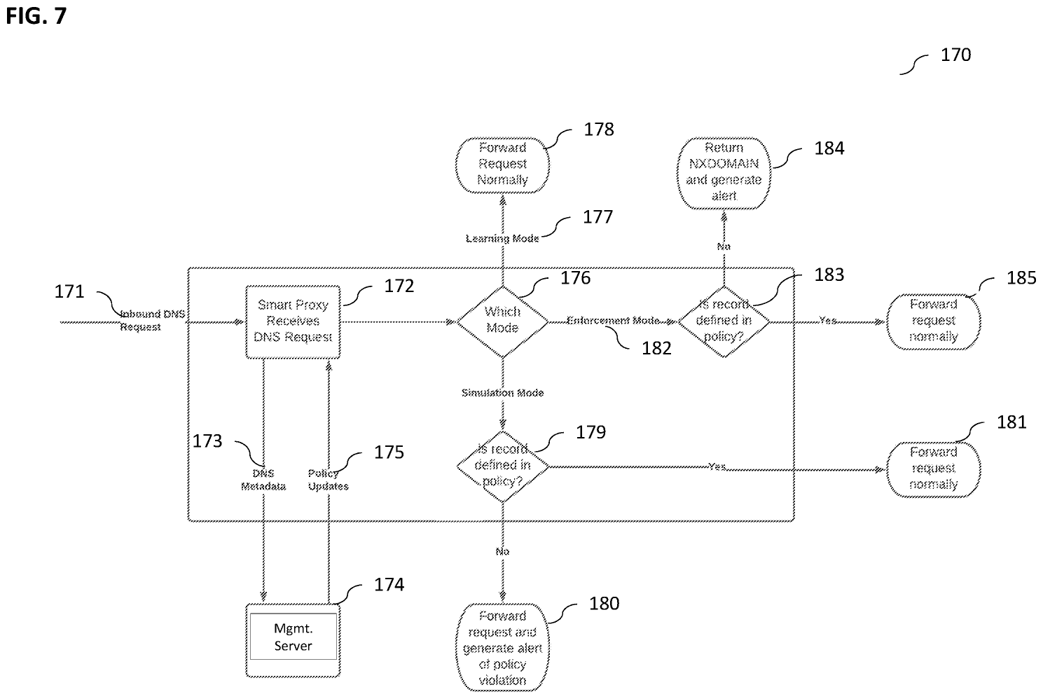

FIG. 7 illustrates an exemplary process 170 for executing one or more DNS proxy decisions, according to some implementations of the current subject matter. The process 170 may be configured to be executed by one or more components of FIG. 6, including, for example, DNS proxy component 163 and/or management server 165.

At 171, an inbound client request may be received by the DNS proxy component 172 (similar to DNS proxy component 163 shown in FIG. 6). The DNS proxy component 172 may transmit a metadata 173 associated with the received request 171 to the management server 174 (similar to the management server 165 shown in FIG. 6). In some exemplary implementations, the metadata may include the received DNS request's details that may be necessary for the management server 174 to compile and/or generate one or more DNS profiles for the application servers from which request 171 may have been received. The DNS profiles may be included in the DNS policy of the system 160, which may be used to check any DNS requests received by the system 160. As discussed above, the DNS policy may be dynamically updated based on any newly requests (e.g., through learning), testing/simulation, and/or any other way.

The DNS proxy component 172 may determine a particular mode 176 (e.g., a learning mode, a testing/simulation mode, an enforcement mode, etc.) that may have been configured for the source IP address associated with the received request. This determination may be performed either in sequence (one after the other) and/or simultaneously with the transmission of the metadata 173 to management server 174. If no mode has been configured for the IP address associated with the received request, the system 160 may automatically assume a learning mode 177 and execute one or more profiling requests from the source associated with the received IP address. In the learning mode, the received requests may be processed, at 178, in the same fashion as they would be if the proxy was acting as a typical DNS proxy server (e.g., without any “smart” capability).

If a determination is made that a testing/simulation mode has been configured for the IP address associated with the received request, the system 160 may, at 179, continue to process/forward all DNS requests and report on any requests that may have been blocked and/or dropped had the enforcement mode 182 has been initiated. The testing/simulation mode 179 may allow testing of the system 160 prior to placement of the system into the enforcement mode 182. When testing/simulation mode 179 is invoked and the source IP address associated with the received request is not defined in the DNS policy of the system 160, the received request 171 may flagged as a violation of the policy (e.g., by virtue of it not being defined in the policy) and an alert may be generated, at 180, to inform the administrator. Alternatively, if the source IP address associated with the received request 171 has been defined in the DNS policy, the received request may be forwarded as usual, at 181. The simulation mode 179 may be running indefinitely to allow for a level of visibility of processing of requests that the current subject matter's application server centric, positive enforcement DNS security system provides. While no requests would be blocked, alerts may still be investigated for further forensic analysis when the servers start behaving differently at the DNS level.

If the enforcement mode 182 is invoked in connection with the received DNS request for a given source IP address, the system 160 may be configured to initially determine whether the RR received in the DNS request has been defined in the DNS policy, at 183. If it has not been defined, the DNS proxy 172 may return an NXDOMAIN response and generate an alert 184 for any requests that fall outside of the profiles contained in the DNS policy, which may be akin to a positive enforcement DNS firewall. If the RR received in the DNS request is contained in the DNS policy for the source IP address from which it originated, the request may be processed normally, at 185.

By turning on the enforcement mode 182 for all application servers 161 (as shown in FIG. 6), the system 160 may be configured to disable an ability for any request to tunnel out of the network using DNS. When the servers are updated in the future, if they start behaving differently at the DNS layer, the system 160 may be able to identify specifically what has changed and request information (e.g., from the application developer and/or provider) for validating the observed behavior changes. If a supply chain attack were to occur, and malicious code was planted into the application server, these erratic DNS requests would be the first indication of that. Additionally, the enforcement mode 182 may be configured to prevent requests from reaching the attacker DNS infrastructure, crippling any attempt at establishing C2 and/or data exfiltration.

When applications are deployed in enterprise environments today that need to connect to the Internet, one expectation is for the application provider to provide a system requirements document that specifies the expected network behavior of the application from a layer 4 perspective. Layer 4 network documentation specifies all of the IP addresses and TCP or UDP ports that the application requires access to over the network, both inbound and outbound. These requirements are used to build the firewall policies needed to allow the network communication necessary for the application to function. Since the DNS protocol has become an avenue to transmit all of the same information over the network that normal network traffic has allowed, the contention of this paper is that the exact same requirements should be expected from application providers for DNS traffic behavior. System requirements documentation at layer 4 normally specifies IP subnets (a logical division of a network specified in specific notation), IP ranges (another notation for defining a portion of a larger network, often specified by using a dash to identify a range between two different IP addresses), or individual addresses that each application server may need to connect to in the course of normal operations. The exact same philosophy can be applied to DNS by specifying domains, subdomains, and individual RRs that applications require to function.

By providing such information, in some implementations, the current subject matter may be configured to bypass the learning mode immediately upon the deployment of the application. Below is a discussion of a format that may be used to provide a required DNS traffic profile for a particular application. One consideration to take into account is that both base operating systems (OS), in addition to the applications running on top of them, each will have unique DNS requirements.

A DNS profile for an individual application may be configured to specify all of the RRs and/or types of responses to be expected by a particular application. A DNS profile for an application server may be configured to specify all RRs and types of corresponding responses that may include an entirety of the DNS traffic behavior that may be required for the base operating system of the server along which all applications are expected to run on that server. In order to capture the full DNS profile for a particular application server, two or more DNS profiles may have to be ingested, e.g., one for the OS on which the application is running, and another one for each application running on top of the OS.

In order to generate an OS DNS profile, operating systems (e.g., with nothing installed beyond the default operating system) may be connected to the DNS proxy 163 (shown in FIG. 6) and/or 172 (shown in FIG. 7) and allowed to run for a predetermined period of time (e.g., 30 days) to collect details observed during that period of time. Update checks may be performed and any subsequent updates may be installed during this period of time to ensure that the generated profile includes events such as system updates that may, for example, only happen periodically. At the end of the process, profiles may be added into the DNS management server 165 to allow for OS selection during manual DNS profile creation using provided DNS profiles.

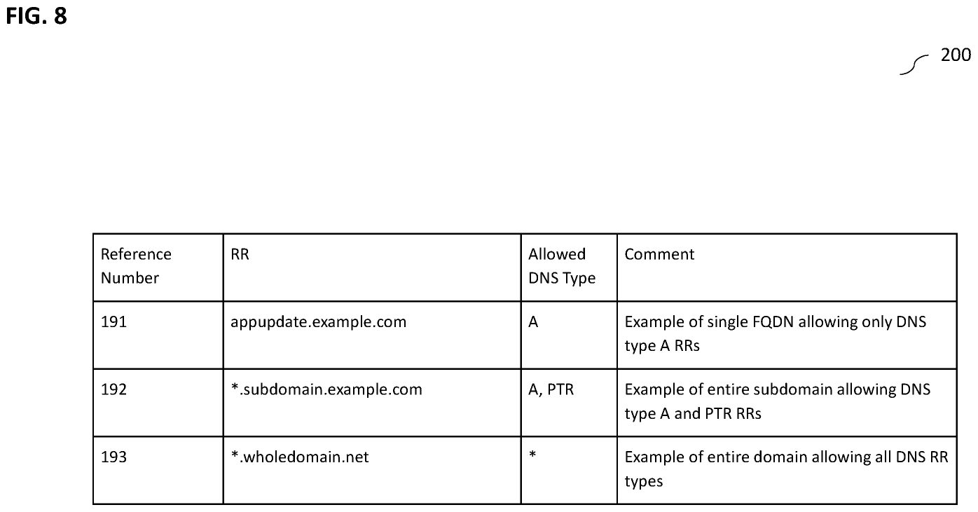

FIG. 8 is an annotated table 200 containing examples 191-193 of fields that may be included for each value pair in the DNS profile, according to some implementations of the current subject matter. Below is an exemplary format for a DNS profile entry:
appupdate.example.com A
   *.subdomain.example.com A,PTR
   *.wholedomain.net*

As shown in table 200, a first field of the DNS profile may specify an RR and/or multiple RRs with either a domain, subdomain, and/or FQDN (e.g., appupdate.example.com, *.subdomain.example.com, *.wholedomain.net). An asterisk (*) may be used as a wildcard in either domain and/or subdomain specifications to indicate that any value may be accepted. For example, in row 191, the RR specified is an entire FQDN. In row 192, notation may be allowed specifying an entire subdomain. In row 193, a full domain may be specified using a wildcard notation.

A second field for each value pair in the DNS profile may specify a type of RR being requested. In some exemplary implementations, there may be a plurality (e.g., approximately 50, a large majority of which are not typically used) of different types of DNS record types. The most commonly used type of DNS record may be an A record. An A record may return an IP address for the requested FQDN, whereas types like TXT and/or PTR may return other types of values, such as, strings of characters. More often than not, DNS tunneling uses DNS types other than type A, to allow for greater flexibility in the data being sent back and forth. Because of this, it is recommended to specify the type when possible, especially when domains or subdomains are being specified, due to the widespread abuse of these lesser used types such as TXT in tunneling. Similarly to the first field, a wildcard using an asterisk (*) may be used to indicate that any DNS RR type may be allowed. Additionally, multiple values may be specified using commas as separators. For example, in row 191, a value type being defined is limited to type A. In row 192, two values may be specified: A and PTR. In row 193, the DNS type may be specified with a wildcard to allow for resolution of any DNS type.

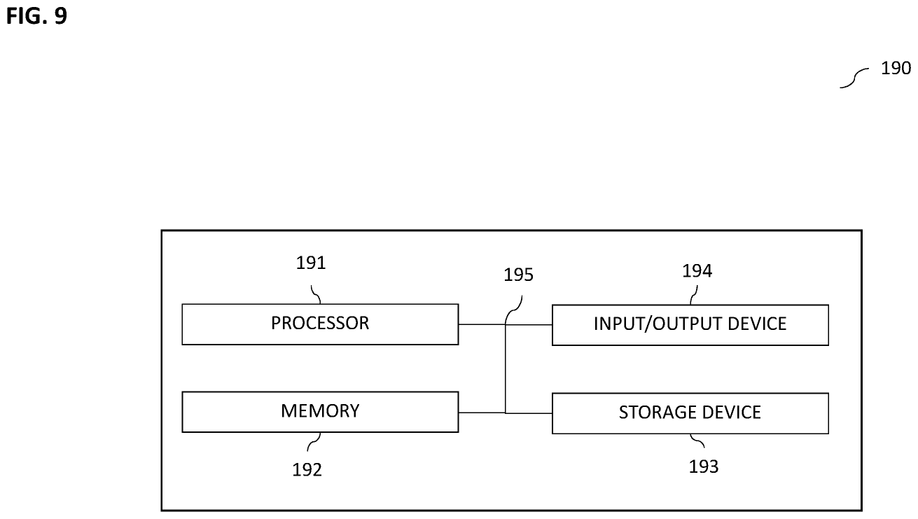

In some implementations, the current subject matter can be configured to be implemented in a system 190, as shown in FIG. 9. The system 190 can include a processor 191, a memory 192, a storage device 193, and an input/output device 194. Each of the components 191, 192, 193 and 194 can be interconnected using a system bus 195. The processor 191 can be configured to process instructions for execution within the system 190. In some implementations, the processor 191 can be a single-threaded processor. In alternate implementations, the processor 191 can be a multi-threaded processor. The processor 191 can be further configured to process instructions stored in the memory 192 or on the storage device 193, including receiving or sending information through the input/output device 194. The memory 192 can store information within the system 190. In some implementations, the memory 192 can be a computer-readable medium. In alternate implementations, the memory 192 can be a volatile memory unit. In yet some implementations, the memory 192 can be a non-volatile memory unit. The storage device 193 can be capable of providing mass storage for the system 190. In some implementations, the storage device 193 can be a computer-readable medium. In alternate implementations, the storage device 193 can be a floppy disk device, a hard disk device, an optical disk device, a tape device, non-volatile solid state memory, or any other type of storage device. The input/output device 194 can be configured to provide input/output operations for the system 190. In some implementations, the input/output device 194 can include a keyboard and/or pointing device. In alternate implementations, the input/output device 194 can include a display unit for displaying graphical user interfaces.

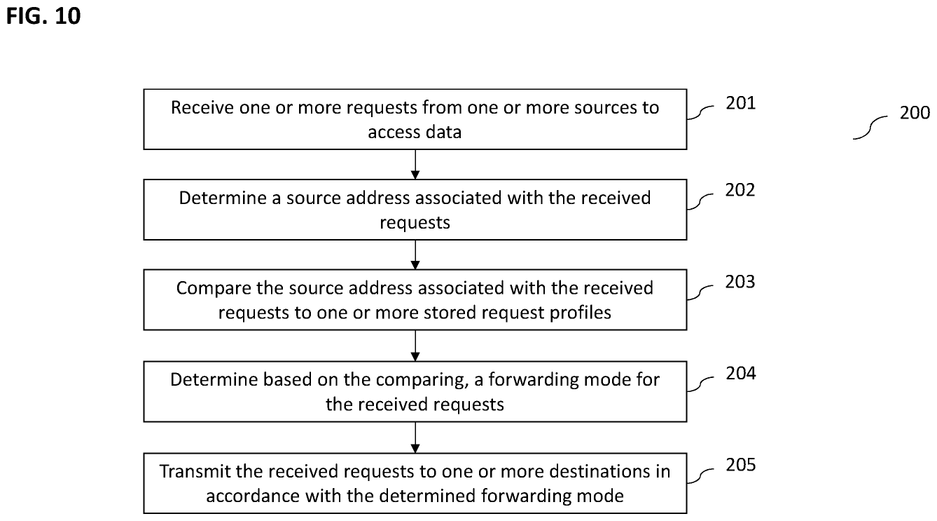

FIG. 10 illustrates an exemplary method 200 for executing a positive domain name service enforcement, according to some implementations of the current subject matter. The method 200 may be executed using one or more components of the system and discussed in connection with FIGS. 1-7. For example, the method 200 may be executed by one or more components of the system 160 shown in FIG. 6, including but not limited to, DNS proxy component 163 and/or management server 165, using one or more processes shown in FIG. 7.

At 201, at least one processor (e.g., DNS proxy component 163 and/or management server 165) may be configured to receive one or more requests from one or more sources to access data. At 202, DNS proxy component 163 and/or management server 165 may be configured to determine a source address associated with the received request(s). At 203, DNS proxy component 163 and/or management server 165 may compare the source address associated with the received requests to one or more stored request profiles (e.g., as may be generated during the learning phase discussed above). At 204, DNS proxy component 163 and/or management server 165 may determine, based on the comparing, a forwarding mode for the received requests, and transmit the received requests to one or more destinations in accordance with the determined forwarding mode, at 205. The destinations may be determined based on the specific mode, such as, the learning mode, the testing/simulation mode, and/or the enforcement mode.

In some implementations, the current subject matter can include one or more of the following optional features. One or more requests may include one or more domain name service (DNS) requests.

In some implementations, one or more requests may include at least one: one or more requests to access data stored on an application server, one or more responses responsive to one or more requests, and any combination thereof.

In some implementations, the method may include generating one or more request profiles based on a plurality of requests to access data, each request profile in one or more request profiles may be associated with a corresponding request to access data in the plurality of requests to access data, and storing the generated request profiles as the stored request profiles. Each request profile may include an identification of the request to access data and a type of the identified request. The identification of the requests may include at least one of the following: a domain name, a subdomain name, a fully-qualified domain name, and any combination thereof.

In some implementations, the forwarding mode may include at least one of the following: a learning mode, a testing mode, an enforcement mode, and any combination thereof.

In some implementations, in the learning mode, at least one processor may be configured to generate and store one or more request profiles based on the received requests, and block transmission of the requests to one or more destinations storing data identified in the received requests. In the testing mode, at least one processor is configured to determine whether the source address associated with the received requests corresponds to one or more stored request profiles and/or whether those profiles include the RR being requested. Upon determining that the RRs received in one or more requests does not correspond to one or more stored request profiles for the source IP address the requests were received from, transmission of the requests to one or more destinations storing data identified in the received requests may be blocked and an alert may be generated. Upon determining that the RRs associated with the received requests corresponds to one or more stored request profiles the source IP address the requests were received from, a simulated transmission of the requests to one or more destinations storing data identified in the received requests may be executed.

In some implementations, in the enforcement mode, at least one processor is configured to determine whether the source address associated with the received requests corresponds to one or more stored request profiles. Upon determining that the RRs associated with the received requests does not correspond to one or more stored request profiles the source IP address the requests were received from, transmission of the requests to one or more destinations storing data identified in the received requests may be blocked. Upon determining that the RRs associated with the received requests corresponds to one or more stored request profiles for the source IP address the requests were received from, the requests may be transmitted to one or more destinations storing data identified in the received requests.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
receiving, using at least one processor, one or more requests from one or more sources to access data;
determining, using the at least one processor, a source address associated with the received one or more requests;
comparing, using the at least one processor, the source address associated with the received one or more requests to one or more stored request profiles;
determining, using the at least one processor, based on the comparing, a forwarding mode for the received one or more requests; and
transmitting, using the at least one processor, the received one or more requests to one or more destinations in accordance with the determined forwarding mode.

2. The method according to claim 1, wherein the one or more requests include one or more domain name service (DNS) requests.

3. The method according to claim 1, wherein the one or more requests include at least one: one or more requests to access data stored on the application server, one or more responses responsive to the one or more requests, and any combination thereof.

4. The method according to claim 1, further comprising
generating one or more request profiles based on a plurality of requests to access data, each request profile in the one or more request profiles is associated with a corresponding request to access data in the plurality of requests to access data; and
storing the generated one or more request profiles as the one or more stored request profiles.

5. The method according to claim 4, wherein each request profile in the one or more request profiles includes an identification of the request to access data and a type of the identified request.

6. The method according to claim 5, wherein the identification of the requests includes at least one of the following: a domain name, a subdomain name, a fully-qualified domain name, and any combination thereof.

7. The method according to claim 1, wherein the forwarding mode includes at least one of the following: a learning mode, a testing mode, an enforcement mode, and any combination thereof.

8. The method according to claim 7, wherein, in the learning mode, the at least one processor is configured to generate and store one or more request profiles based on the received one or more requests.

9. The method according to claim 8, wherein, in the learning mode, the at least one processor is configured to block transmission of the one or more requests to the one or more destinations storing data identified in the received one or more requests.

10. The method according to claim 7, wherein, in the testing mode, the at least one processor is configured to
determine whether the source address associated with the received one or more requests corresponds to one or more stored request profiles, wherein
upon determining that the source address associated with the received one or more requests does not correspond to one or more stored request profiles, generating an alert;
upon determining that the source address associated with the received one or more requests corresponds to one or more stored request profiles, executing a simulated transmission of the one or more requests to the one or more destinations storing data identified in the received one or more requests.

11. The method according to claim 10, wherein upon determining that the source address associated with the received one or more requests does not correspond to one or more stored request profiles, blocking transmission of the one or more requests to the one or more destinations storing data identified in the received one or more requests.

12. The method according to claim 7, wherein, in the enforcement mode, the at least one processor is configured to
determine whether the source address associated with the received one or more requests corresponds to one or more stored request profiles, wherein
upon determining that the source address associated with the received one or more requests does not correspond to one or more stored request profiles, blocking transmission of the one or more requests to the one or more destinations storing data identified in the received one or more requests;
upon determining that the source address associated with the received one or more requests corresponds to one or more stored request profiles, transmitting the one or more requests to the one or more destinations storing data identified in the received one or more requests.

13. A system comprising:
at least one programmable processor; and
a non-transitory machine-readable medium storing instructions that, when executed by the at least one programmable processor, cause the at least one programmable processor to perform operations comprising:
receiving one or more requests from one or more sources to access data;
determining a source address associated with the received one or more requests;
comparing the source address associated with the received one or more requests to one or more stored request profiles;
determining, based on the comparing, a forwarding mode for the received one or more requests; and
transmitting the received one or more requests to one or more destinations in accordance with the determined forwarding mode.

14. The system according to claim 13, wherein the one or more requests include one or more domain name service (DNS) requests.

15. The system according to claim 13, wherein the one or more requests include at least one: one or more requests to access data stored on the application server, one or more responses responsive to the one or more requests, and any combination thereof.

16. The system according to claim 13, wherein the operations further comprise
generating one or more request profiles based on a plurality of requests to access data, each request profile in the one or more request profiles is associated with a corresponding request to access data in the plurality of requests to access data; and
storing the generated one or more request profiles as the one or more stored request profiles.

17. The system according to claim 16, wherein each request profile in the one or more request profiles includes an identification of the request to access data and a type of the identified request.

18. The system according to claim 17, wherein the identification of the requests includes at least one of the following: a domain name, a subdomain name, a fully-qualified domain name, and any combination thereof.

19. The system according to claim 13, wherein the forwarding mode includes at least one of the following: a learning mode, a testing mode, an enforcement mode, and any combination thereof.

20. The system according to claim 19, wherein, in the learning mode, the operations further comprise generating and storing one or more request profiles based on the received one or more requests.

21. The system according to claim 20, wherein, in the learning mode, the operations further comprise blocking transmission of the one or more requests to the one or more destinations storing data identified in the received one or more requests.

22. The system according to claim 19, wherein, in the testing mode, the operations further comprise
determining whether the source address associated with the received one or more requests corresponds to one or more stored request profiles, wherein
upon determining that the source address associated with the received one or more requests does not correspond to one or more stored request profiles, generating an alert;
upon determining that the source address associated with the received one or more requests corresponds to one or more stored request profiles, executing a simulated transmission of the one or more requests to the one or more destinations storing data identified in the received one or more requests.

23. The system according to claim 22, wherein upon determining that the source address associated with the received one or more requests does not correspond to one or more stored request profiles, blocking transmission of the one or more requests to the one or more destinations storing data identified in the received one or more requests.

24. The system according to claim 19, wherein, in the enforcement mode, the operations further comprise
determining whether the source address associated with the received one or more requests corresponds to one or more stored request profiles, wherein
upon determining that the source address associated with the received one or more requests does not correspond to one or more stored request profiles, blocking transmission of the one or more requests to the one or more destinations storing data identified in the received one or more requests;
upon determining that the source address associated with the received one or more requests corresponds to one or more stored request profiles, transmitting the one or more requests to the one or more destinations storing data identified in the received one or more requests.

25. A computer program product comprising a non-transitory machine-readable medium storing instructions that, when executed by at least one programmable processor, cause the at least one programmable processor to perform operations comprising:
receiving one or more requests from one or more sources to access data;
determining a source address associated with the received one or more requests;
comparing the source address associated with the received one or more requests to one or more stored request profiles;
determining, based on the comparing, a forwarding mode for the received one or more requests; and
transmitting the received one or more requests to one or more destinations in accordance with the determined forwarding mode.
